(19) United States
(12) Patent Application Publication
(10) Pub. No.: US 2012/0025503 A1
(43) Pub. Date: Feb. 2, 2012

(54) UNITARY DIFFUSERS FOR USE WITH AIR BAG CUSHION INFLATORS

(76) Inventors: Anthony M. Young, Malad, ID (US); Jared M. Jensen, Pleasant View, UT (US); Kurt L. Gamill, Layton, UT (US)

(21) Appl. No.: 12/845,286

(22) Filed: Jul. 28, 2010

(51) Int. Cl. B60R 21/26; B23P 17/00

(52) U.S. Cl. 280/740; 29/896.6

(57) ABSTRACT

Diffusers adapted for use with air bag cushion inflators and air bag systems may comprise a unitary or integral hollow body defining a diffusion chamber. The hollow body may include a first longitudinal end having an aperture and an opposing second longitudinal end that is at least substantially enclosed. A module attach feature may be disposed between the first longitudinal end and the second longitudinal end. The module attach feature may comprise a lateral extent that is greater than a lateral extent of the hollow body. A plurality of apertures extending through the hollow body may be disposed between the module attach feature and the second longitudinal end. Air bag systems employing such diffusers may include an inflator including the diffuser and at least one inflatable cushion, a portion of which is coupled to the diffuser.

### TECHNICAL FIELD

The present disclosure relates generally to inflatable air bag cushions for motor vehicles. More specifically, various embodiments of the present disclosure relate to devices, systems and methods used in inflatable air bag cushions for motor vehicles.

### BACKGROUND

Modern motor vehicles typically employ various occupant protection systems that self-actuate from an undeployed to a deployed state without the need for intervention by the occupant. Such systems often include an inflatable occupant protection system in the form of a cushion or bag, commonly referred to as an “air bag cushion.” Such air bag cushions may deploy into one or more locations within the vehicle between the occupant and certain parts of the vehicle interior, such as the doors, steering wheel, instrument panel, dashboard or the like, to prevent or cushion the occupant from forcibly striking such parts of the vehicle interior.

Various types or forms of occupant protection systems have been developed or tailored to provide desired vehicle occupant protection based on either or both the position or placement of the occupant within the vehicle and the direction or nature of the vehicle collision. For example, driver and passenger inflatable cushion installations have found wide usage for providing protection to drivers and front seat passengers, respectively, in the event of head-on type of collision. Other installations have found wide usage for providing protection to vehicle occupants in the event of a side impact (e.g., side collision, roll-over).

The air bag cushion is conventionally housed in an uninflated and folded condition to minimize space requirements. Upon actuation of the system, the air bag cushion may be inflated with gas supplied or produced by a device commonly referred to as an “inflator.” Such inflators may typically be attached to a gas guide for the air bag cushion. As a result, conventional air bag cushions may include one or more features to facilitate attachment of the gas guide to the inflator. However, conventional inflators typically employ multiple components that may be individually formed (e.g., machined, forged, stamped, etc.) and attached together to provide a structure to facilitate attachment to the gas guide.

### BRIEF SUMMARY

Various embodiments of the present disclosure comprise diffusers for use with an air bag cushion inflator having a reduced number of components resulting in a simplified, cheaper and more structurally sound diffuser. In one or more embodiments, a diffuser may comprise a unitary or integral hollow body defining a diffusion chamber. The hollow body may include a first longitudinal end having an aperture and an opposing second longitudinal end that is at least substantially enclosed. A module attach feature may be disposed between the first longitudinal end and the second longitudinal end. The module attach feature may comprise a lateral extent that is greater than a lateral extent of the hollow body. A plurality of apertures extending through the hollow body may be disposed between the module attach feature and the second longitudinal end.

Additional embodiments of the present disclosure include inflatable air bag systems. According to at least one embodiment, such system may comprise at least one inflatable cushion and an inflator. The inflator may include an elongated hollow tube with a first longitudinal tube end and a second longitudinal tube end. An initiator may be coupled to the first longitudinal tube end and a diffuser may be disposed at the second longitudinal tube end. The diffuser may be coupled to a portion of the at least one inflatable cushion. The diffuser may include a unitary hollow body comprising a first body end and a second body end that is at least substantially enclosed. An inflatable cushion attachment feature may be disposed between the first body end and the second body end, and may facilitate coupling the diffuser to the portion of the at least one inflatable cushion. A plurality of apertures may be disposed in the diffuser between the inflatable cushion attachment feature and the second body end.

Yet other embodiments of the present disclosure comprise methods of making a diffuser configured for use with an air bag cushion inflator. One or more embodiments of such methods may comprise forming a unitary hollow body. The unitary hollow body may be formed to include a first longitudinal end with an aperture therein and an opposing second longitudinal end that is at least substantially enclosed. A module attach feature may be disposed between the first longitudinal end and the second longitudinal end, such module attach feature having a lateral extent that is greater than a lateral extent of the hollow body. A plurality of apertures may be disposed in the hollow body and located between the module attach feature and the second longitudinal end.

### BRIEF DESCRIPTION OF THE SEVERAL VIEWS OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the disclosure's scope, the exemplary embodiments of the disclosure will be described with additional specificity and detail through use of the accompanying drawings in which:

FIG. 1 is a cross-sectioned side view of an air bag inflator according to at least one embodiment;

FIG. 2 is a cross-sectioned view of at least one embodiment of a diffuser including an integral module attach feature;

FIG. 3 is a cross-section view of at least one embodiment of a diffuser including a module attach feature adapted as a sleeve; and

FIG. 4 is a side view of the interior of a motor vehicle illustrating an inflatable air bag system according to at least one embodiment of the disclosure;

FIG. 5 is a flow chart illustrating at least one embodiment of a method of making a diffuser.

### DETAILED DESCRIPTION

The illustrations presented herein are, in some instances, not actual views of any particular inflatable air bag system, air bag inflator, or diffuser, but are merely idealized representations which are employed to describe the present disclosure. Additionally, elements common between figures may retain the same numerical designation.

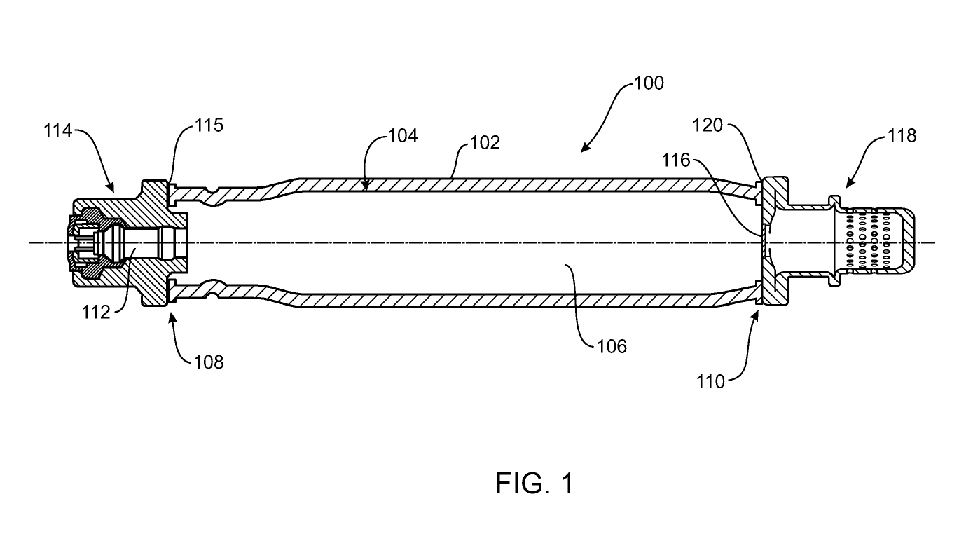

Various embodiments of the present disclosure include air bag cushion inflators including a unique diffuser. FIG. 1 is a cross-sectioned view illustrating an air bag inflator 100 according to at least one embodiment of the present disclosure. The inflator 100 generally includes an elongated hollow tube 102 defining a chamber 104 for enclosing a quantity of fluid therein, designated by the reference numeral 106. In the embodiment shown in FIG. 1, the fluid 106 may comprise a stored fluid, such as a pressurized expandable fluid. However, other embodiments of the inflator 100 may be adapted to enclose a quantity of gas generant adapted to be converted into a supply of inflation fluid during deployment, as well as a combination of stored fluid and gas generant, commonly referred to as a “hybrid”.

The hollow tube 102 includes opposing first and second longitudinal ends, 108 and 110, respectively. An initiator 112 may be coupled to the first longitudinal end 108, for instance as part of an initiator assembly 114. Such an initiator assembly 114 may be coupled to the first longitudinal end 108 using, for example, an inertial weld 115. The initiator 112 is adapted to inflate (e.g., ignite) the stored fluid 106 upon receipt of an electrical signal, such as may be generated by a sensor (not shown) upon the sensing of a collision.

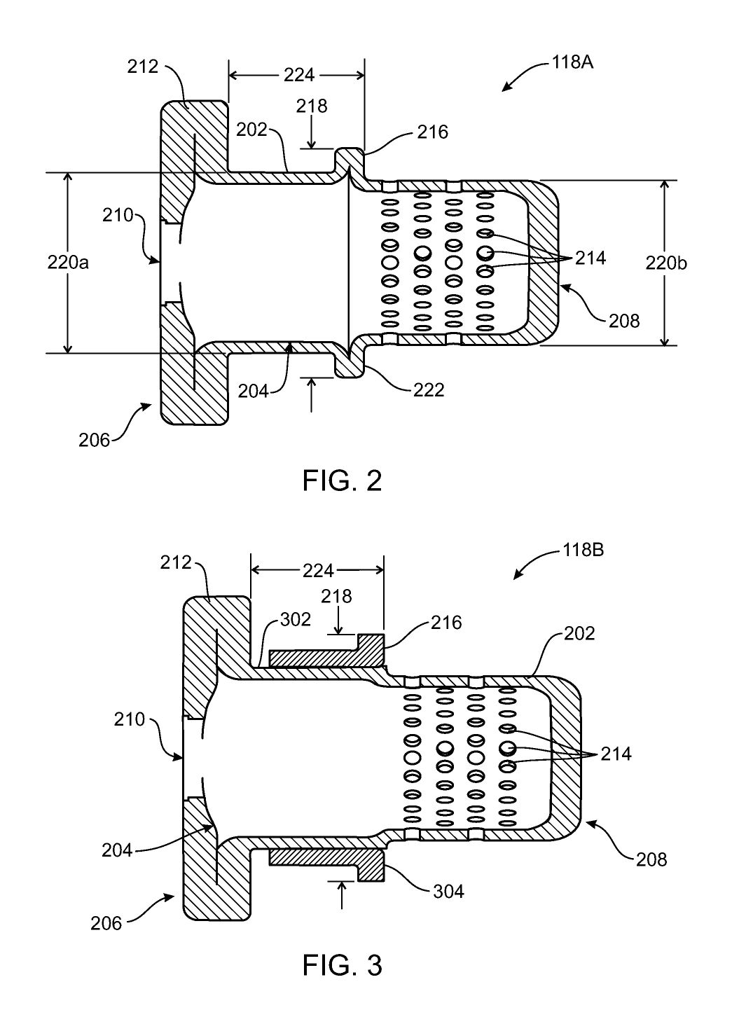

The second longitudinal end 110 of the hollow tube 102 may be enclosed with a burst disk 116. A diffuser 118 may be formed integral with or appropriately coupled to the second longitudinal end 110 of the hollow tube 102. For example, the diffuser 118 may be coupled to the second longitudinal end 110 with an inertial weld 120, or the diffuser 118 may be formed integral with the hollow tube 102. Some examples of diffusers 118 are shown in FIGS. 2 and 3.

Referring to FIG. 2, the diffuser 118A comprises a unitary hollow body 202 defining a diffusion chamber 204. The hollow body 202 may include a first longitudinal end 206 and an enclosed, or substantially enclosed second longitudinal end 208, which may also be characterized as a first body end 206 and second body end 208, respectively. The first longitudinal body end 206 may be coupled to the second longitudinal end 110 of the inflator 100, as shown in FIG. 1, and may include an aperture 210 enabling fluid communication between the chamber 104 of the inflator 100 and the diffusion chamber 204. The aperture 210 may be sized and configured to control the rate of gas flow from the chamber 104 of the inflator 100 into the diffusion chamber 204. In at least some embodiments, the first body end 206 may include a flange 212 adapted to facilitate coupling the diffuser 118A to the inflator 100. The flange 212 may comprise a crimp formed at the first body end 206 of the unitary hollow body 202 providing a substantial surface area to facilitate adhering (e.g., welding) the flange 212 to the second longitudinal end 110 of the hollow tube 102.

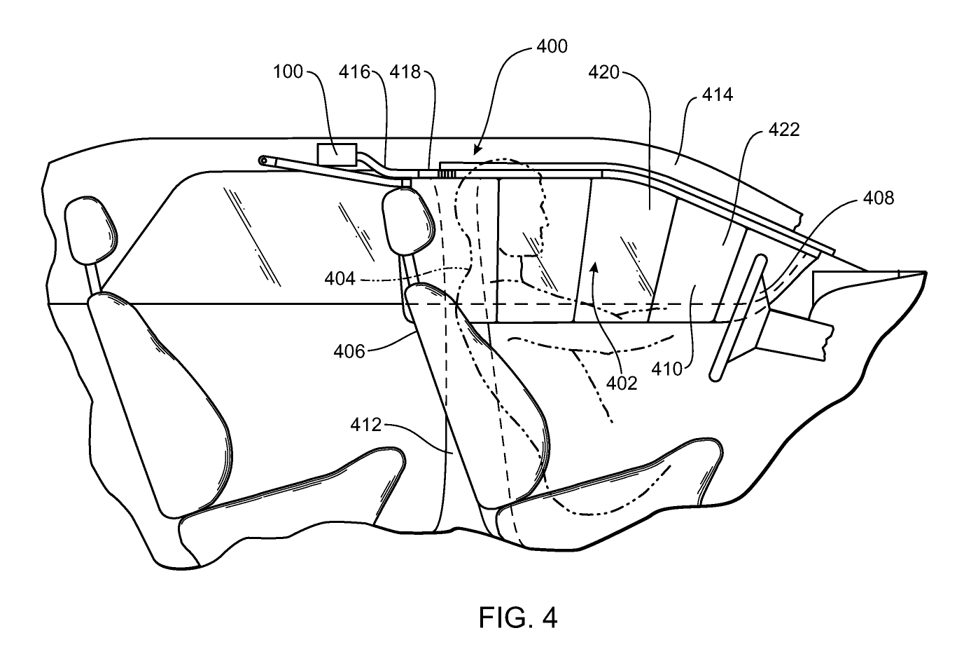

According to at least one feature, the diffuser 118A includes a module attach feature 216 disposed between the first body end 206 and the second body end 208. The module attach feature 216 is adapted to facilitate attachment of the diffuser 118A to a module of an inflatable air bag system, and may also be characterized as an inflatable cushion attachment feature. For example, the module attach feature 216 may facilitate attachment of the diffuser 118A to a gas guide (e.g., hose 416 in FIG. 4) for guiding an inflation fluid from the inflator 100, through the diffuser 118A and into one or more cells of an air bag cushion.

The module attach feature 216 may comprise a lateral extent 218 (e.g., an outer diameter of a cylindrically-shaped diffuser 118A) that is greater than a lateral extent 220a, 220b of the hollow body 202. According to various embodiments, the lateral extent 218 of the module attach feature 216 may be sufficiently greater than the lateral extent 220a of the hollow body 202 (e.g., between the first body end 206 and the module attach feature 216) to facilitate retention of a module, such as a gas guide, of an inflatable air bag system. By way of example and not limitation, the lateral extent 218 of the module attach feature 216 may be greater than the lateral extent 220a of the hollow body 202 by about 5 mm or more. In some embodiments, the lateral extent 220a of the hollow body 202 between the first body end 206 and the module attach feature 216 may be larger than the lateral extent 220b of the hollow body 202 between the module attach feature 216 and the second body end 208. The lateral extent 220b of the hollow body 202 (e.g., between the module attach feature 216 and the second body end 208) may be selected to provide sufficient clearance between the lateral extent 220b and a module (e.g., a gas guide) attached to the hollow body to facilitate the flow of a gas into the module (e.g., gas guide). By way of example and not limitation, the lateral extent 220b of the hollow body 202 may be adapted to provide a clearance of about 5 mm or more between the lateral extent 220b and an inner wall of a module (e.g., gas guide) of an inflatable air bag system attached to the diffuser 118A.

The module attach feature 216 may be formed integral with the hollow body 202, such that the entire diffuser 118 comprises a single unitary component. For example, the module attach feature 216 may comprise a portion or section of the hollow body 202 that has been folded outward, thereby forming an overlapped portion referred to herein as a crimped bend 222.

The hollow body 202 may comprise a plurality of apertures 214 disposed between module attach feature 216 and the second body end 208. In conventional diffusers, a filter may be disposed in the diffusion chamber 204 to filter out particulate that may be forced into the diffusion chamber 204 with an inflation fluid 106 (see FIG. 1). By contrast, according to at least one feature, the plurality of apertures 214 may be sized and configured to filter particulate from an inflation fluid 106 (see FIG. 1) passing through the apertures 214, without the need for a separate filter. The diffuser 118 may, therefore, eliminate a separate filter by performing such filtering functions with the plurality of apertures 214. Such apertures 214 may comprise any of a variety of shapes and sizes. For example, the apertures 214 may be circular, oval, rectangular, slot-shaped, etc. as well as any combination of two or more shapes. By way of example and not limitation, the plurality of apertures 214 according to one or more implementations may be circular, or substantially circular in shape, and may include diameters selected from the range between about 0.5 mm and about 2.5 mm.

Turning to FIG. 3, the diffuser 118B is similar in many respects to the diffuser 118A in FIG. 2. In general, as discussed in additional detail above, the diffuser 118A includes a unitary hollow body 202 defining a diffusion chamber 204, a first longitudinal end 206 with an aperture 210 and an enclosed, or substantially enclosed second longitudinal end 208. The first body end 206 may include a flange 212. A plurality of apertures 214 sized and configured to filter particulate from an inflation fluid passing through the apertures 214 may be disposed in the hollow body 202 between the second body end 208 and the module attach feature 216.

One difference between the diffuser 118A of FIG. 2 and the diffuser 118B of FIG. 3 is the module attach feature 216 of the diffuser 118B is not integral with the hollow body 202. Instead, the module attach feature 216 comprises a component that may be disposed on an outer surface 302 of the hollow body 202. For example, the module attach feature 216 may comprise a sleeve 304 disposed on the hollow body 202, and may be configured with an L-shaped, or substantially L-shaped cross-section.

Additional embodiments of the present disclosure relate to inflatable air bag systems employing inflators having diffusers, such as those described above. FIG. 4 is a side view of the interior of a motor vehicle illustrating an inflatable air bag system 400 according to at least one embodiment of the disclosure. The inflatable air bag system 400 includes an inflator, such as inflator 100 above, and a close proximity inflatable air bag cushion 402 in the form of an inflatable curtain. The inflatable air bag system 400 and the air bag cushion 402 thereof are intended to provide protection for a person 404 sitting in a seat 406 in the vehicle. In an accident in which the vehicle is decelerated, the person 404 may tend to move forwardly towards the steering wheel 408, but may be restrained by a conventional seat belt and/or air bag. In the case of a side impact (e.g., side collision, roll-over), the person 404 may strike the window 410 in the door beside the person 404, the vehicle B-pillar 412, or both. There is also the risk that if the glass in the window 410 breaks, the head of the person 404 may be thrown out of the window opening.

The inflatable air bag cushion 402, which may also be characterized as an inflatable cushion and is shown in the operative state in FIG. 4, is initially retained in a recess provided in the door frame 414 located above the door of the vehicle. The recess may extend over more than simply a linear portion of the door frame so that the two ends of the recess may not be in alignment with the main part of the recess. The inflator 100 is adapted to provide an inflation fluid to the air bag cushion 402 for its inflation.

The inflator 100 may be associated with a sensor (not shown) which senses a side impact situation and activates the inflator 100 (e.g., the initiator 112 in FIG. 1) at the appropriate instant. The inflator 100 may include a diffuser 118 according to any of the embodiments described above (see, e.g., FIGS. 1-3). A module attach feature 216 (see FIGS. 2 and 3) of the diffuser 118 may be connected by a hose 416 to a duct 418, which duct 418 forms a part of the inflatable air bag cushion 402. The air bag cushion 402 may include a plurality of cells 420 extending at least substantially parallel.

When an accident occurs, such as side impact, the inflator 100 produces, forms or otherwise supplies an inflation fluid, which is passed through the diffuser 118 into the hose 416 and then the duct 418 and inflates the cells 420. The inflatable air bag cushion 402 thus moves from its initial stored position within the recess in the door frame 414 to the operative position shown in FIG. 4. That is, the air bag cushion extends downwardly from the top of the door frame 414 to form a generally flat structure located between at least a portion of the person 404 and a portion of the motor vehicle (e.g., between the head of the person 404 and the adjacent window 410 or B-pillar 412).

It is noteworthy, that while the embodiment described with reference to FIG. 4 involves an air bag cushion adapted for use as an inflatable curtain 402, other embodiments of inflatable air bag systems of the present disclosure may employ a number of other types of air bag cushions, including, but not limited to other side impact (e.g., head, thorax, combined) air bag cushions, knee air bag cushions, as well as other air bag cushions for use in a motor vehicle.

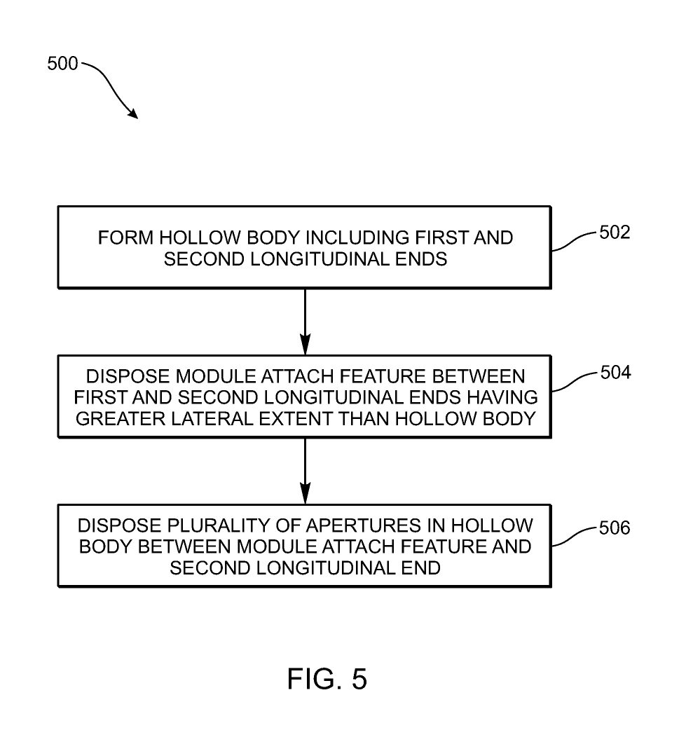

Further implementations of the present disclosure relate to methods of making a diffuser adapted for use with an air bag cushion inflator. FIG. 5 is a flow chart illustrating at least one embodiment of a method 500 of making a diffuser, such as a diffuser 118, 118A, 118B of FIGS. 1-3. The steps associated with the method 500 of FIG. 5 are described hereafter with reference to elements illustrated in FIGS. 1-3 for illustrative purposes and not by way of limitation. Initially, a unitary hollow body 202 may be formed including first and second longitudinal ends (e.g., first longitudinal body end 206 and second longitudinal body end 208, respectively) 502. The first longitudinal end 206 may include an aperture 210 therein that is sized and configured to control the rate of gas flow into the hollow body 202. The opposing second longitudinal end 208 may be at least substantially enclosed. In at least one implementation of method 500, the hollow body 202 may be formed by deep draw stamping operations resulting in a unitary hollow body 202 having the aperture at the first longitudinal end 206 and an enclosed second longitudinal end 208.

At operation block 504, a module attach feature 216 may be disposed between the first longitudinal end 206 and the second longitudinal end 208. The module attach feature 216 may include a lateral extend thereof that is greater than a lateral extent of the hollow body 202. In at least some implementations, the module attach feature 216 may be formed integral to the unitary hollow body 202. For example, the module attach feature 216 may be disposed in the hollow body 202 by folding a portion or section of the hollow body 202 outward, thereby forming an overlapped portion identified with reference to FIG. 2 above as a crimped bend 222. According to other implementations, the module attach feature 216 may be disposed between the first and second longitudinal ends 206, 208, respectively, of the hollow body 202 by disposing a component on an outer surface of the hollow body 202. For example, the module attach feature 216 may comprise a sleeve, such as sleeve 304 of FIG. 3, disposed on the hollow body 202. In some embodiments, the sleeve 304 may comprise an L-shaped, or substantially L-shaped cross-section.

At operation block 506, a plurality of apertures 214 may be disposed in the hollow body 202 such that the apertures 214 are located between the module attach feature 216 and the second longitudinal end 208. The apertures 214 may be adapted to operate as a filter for the diffuser. For example, the apertures 214 may be sized and configured to filter particulate from an inflation fluid passing through the apertures. By way of example and not limitation, the plurality of apertures 214 may be formed to comprise a circular or oval shape and may include diameters selected from the range between about 0.5 mm and about 2.5 mm.

The various embodiments of the present disclosure result in diffusers that are unitary and may include integral filtering. Such unitary diffusers substantially reduce the costs associated with conventional diffusers having multiple separate components and are substantially easier and cheaper to manufacture.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A diffuser for use with an air bag cushion inflator, comprising:
a unitary hollow body defining a diffusion chamber, the hollow body comprising a first longitudinal end having an aperture and an opposing second longitudinal end at least substantially enclosed;
a module attach feature disposed between the first longitudinal end and the second longitudinal end, the module attach feature comprising a lateral extent that is greater than a lateral extent of the hollow body; and
a plurality of apertures extending through the hollow body and disposed between the module attach feature and the second longitudinal end.

2. The diffuser of claim 1, wherein the lateral extent of the hollow body between the first longitudinal end and the module attach feature is larger than the lateral extent of the hollow body between the module attach feature and the second longitudinal end.

3. The diffuser of claim 1, wherein the module attach feature is integral with the hollow body.

4. The diffuser of claim 3, wherein the module attach feature comprises a crimped bend formed in the hollow body.

5. The diffuser of claim 1, wherein the module attach feature is disposed on an outer surface of the hollow body.

6. The diffuser of claim 5, wherein the module attach feature comprises a sleeve disposed on the outer surface of the hollow body.

7. The diffuser of claim 6, wherein the sleeve comprises an at least substantially L-shaped cross-section.

8. The diffuser of claim 1, wherein the plurality of apertures are sized and configured to filter particulate from a fluid passing through the plurality of apertures.

9. The diffuser of claim 8, wherein the plurality of apertures comprise diameters between about 0.5 mm and 2.5 mm.

10. An inflatable air bag system, comprising:
at least one inflatable cushion; and
an inflator including:
an elongated hollow tube;
an initiator coupled to a first longitudinal tube end of the elongated hollow tube; and
a diffuser disposed at a second longitudinal tube end of the elongated hollow tube, the diffuser being coupled to a portion of the at least one inflatable cushion and comprising:
a unitary hollow body including a first body end and a second body end, the second body end being at least substantially enclosed;
an inflatable cushion attachment feature disposed between the first body end and the second body end coupling the diffuser to the portion of the at least one inflatable cushion; and
a plurality of apertures disposed in the diffuser between the inflatable cushion attachment feature and the second body end.

11. The inflatable air bag system of claim 10, wherein the at least one inflatable cushion comprises an inflatable curtain.

12. The inflatable air bag system of claim 10, wherein the inflatable cushion attachment feature of the diffuser is integral with the hollow body of the diffuser.

13. The inflatable air bag system of claim 12, wherein the inflatable cushion attachment feature comprises a crimp formed in the hollow body of the diffuser.

14. The inflatable air bag system of claim 10, wherein the module attach feature is disposed on an outer surface of the hollow body.

15. The inflatable air bag system of claim 14, wherein the module attach feature comprises a sleeve disposed on the outer surface of the hollow body.

16. A method of making a diffuser configured for use with an air bag cushion inflator, comprising:
forming a unitary hollow body including a first longitudinal end with an aperture therein and an opposing second longitudinal end at least substantially enclosed;
disposing a module attach feature between the first longitudinal end and the second longitudinal end, wherein the module attach feature has a lateral extent greater than a lateral extent of the hollow body; and
disposing a plurality of apertures in the hollow body located between the module attach feature and the second longitudinal end.

17. The method of claim 16, wherein forming the hollow body including the first longitudinal end with an aperture therein and the opposing second longitudinal end at least substantially enclosed comprises forming the hollow body by a deep draw stamping operation.

18. The method of claim 16, wherein disposing the module attach feature comprises forming a module attach feature integral with the unitary hollow body.

19. The method of claim 16, wherein disposing the module attach feature comprises disposing a sleeve on an outer surface of the hollow body.

20. The method of claim 16, wherein disposing the plurality of apertures in the hollow body comprises disposing a plurality of apertures sized and configured to filter particulate from a fluid passing through the plurality of apertures.
